(19) United States
(12) Patent Application Publication
(10) Pub. No.: US 2022/0361546 A1
(43) Pub. Date: Nov. 17, 2022

(54) PLUSH ANIMAL TOYS WITH INCORPORATED FLAVOR COMPOSITIONS

(71) Applicant: Logical Brands, Inc., Nashville, TN (US)

(72) Inventors: Lendy Beatty, Playa Del Rey, CA (US); Robert Edmon Guisinger, Cincinnati, OH (US); Nelly Bulgarelli, Loveland, OH (US)

(21) Appl. No.: 17/743,604

(22) Filed: May 13, 2022

Related U.S. Application Data
(60) Provisional application No. 63/188,683, filed on May 14, 2021.

(51) Int. Cl. A23L 27/00; A01K 15/02

(52) U.S. Cl. CPC A23L 27/72; A01K 15/026

(57) ABSTRACT

Non-toxic, polymeric plush animal toys with incorporated natural food flavor compositions are shown and described. The flavor compositions are microencapsulated in a natural protein shell, and the microcapsules are incorporated in a mesh liner. Along with a plush outer layer, the mesh liner defines a fabric enclosure that encloses a compressible fill material. When an animal bites into the toy, the microcapsules rupture, and the food flavor composition diffuses through the mesh liner and plush outer layer.

### CROSS-REFERENCE TO RELATED APPLICATIONS

This application claims the benefit of U.S. Provisional Patent Application No. 63/188,683, filed on May 14, 2021, the entirety of which is hereby incorporated by reference.

### FIELD

The present disclosure relates to animal toys, and more particularly, to plush animal toys with incorporated flavor compositions.

### BACKGROUND

Stuffed plush toys are popular with pets. Their soft feel and compressibility provide an enjoyable and stimulating form of engagement. To further increase engagement, it is also desirable to provide a means of stimulating other senses to keep the pet's attention. Dogs have senses of smell that are many thousand times greater than humans, and toys that produce attractive scents engage dogs for extended play. Pet obesity has also increased in recent years, making toys that provide a non-caloric means of engaging pets desirable.

Pets mainly engage toys with their teeth, and as a result, sometimes rip and tear their toys. This can create a health hazard for the pet if the toy comprises toxic materials. Thus, it is desirable to provide toys that are non-toxic. To ensure their durability and ability to withstand prolonged chewing while remaining attractive to animals, it would be desirable to provide non-toxic, plush, stuffed animal toys (e.g., balls, rings, bones) comprising incorporated flavor compositions that give off a scent and which are “natural flavors.” Non-limiting examples of natural flavors include natural beef, bacon, sweet potato pie, peanut butter, cheddar cheese, turkey, and chicken flavors. However, incorporating such flavor compositions into plush, stuffed animal toys is difficult. The ability to incorporate the compositions into a plush outer layer, such as in the form of a dye, is limited by the ability of the plush fabric to absorb the composition. In addition, the flavor composition is likely to leach out or be degraded by animal saliva. Even without these issues, incorporating the flavor composition in the outer layer may subject the toy to more rapid flavor composition losses through increased diffusion into the atmosphere regardless of whether a pet is playing with the toy.

Incorporating scents into the fill used in stuffed toys also has drawbacks. It is difficult or impossible to maintain the scent compound exclusively at the outer regions of the fill. As a result, some amount of the scent compound will remain buried deep in the toy and will not diffuse—or will diffuse too slowly—to the outer surface of the toy. In addition, some scents are toxic and pose a health hazard if ingested by the animal. Thus, a need has arisen for animal toys and processes of making the same which address the foregoing issues.

### BRIEF DESCRIPTION OF THE DRAWINGS

The disclosure will now be described, by way of example, with reference to the accompanying drawings, in which:

FIG. 1 is front elevational view of a disk-shaped, plush stuffed animal toy with an incorporated flavor composition;

FIG. 2 is a front elevational view of an egg-shaped, plush stuffed animal toy with an incorporated flavor composition;

FIG. 3 is a front elevational view of a bone-shaped, plush stuffed animal toy with an incorporated flavor composition;

FIG. 4 is an exploded view of the components of a fabric laminate used to make the plush stuffed animal toys of FIGS. 1-3 in which the components are shown in an unlaminated configuration;

FIG. 5 is a close-up view of a portion of the plush stuffed animal toy of FIG. 3 with a seam partially removed to show the filler enclosed by the fabric enclosure;

FIG. 6 is a magnified view of a polyester mesh with incorporated food flavor microcapsules used in the animal toys of FIGS. 1-3;

FIG. 7 is a further magnified view of a polyester mesh with incorporated food flavor microcapsules used in the animal toys of FIGS. 1-3;

FIG. 8 is a flow chart depicting a method of making a plush pet toy comprising a natural food flavor composition; and

FIG. 9 is a flow chart depicting a method of incorporating microencapsulated natural food flavors into a mesh fabric used to make a plush pet toy.

### DETAILED DESCRIPTION

The present disclosure relates to non-toxic, stuffed, plush animal toys having incorporated, natural food flavor compositions. In a first aspect of the present disclosure, an animal toy is provided which comprises a fabric enclosure comprising an outer fabric layer and an inner mesh fabric layer. The animal toy also comprises a plurality of microcapsules comprising an encapsulated flavor composition, and the plurality of microcapsules is incorporated in the inner fabric layer. In certain examples, the microcapsules have a protein shell, and the flavor composition is a liquid. The protein is preferably a hydrocolloid, more preferably a gelatin, and still more preferably, one selected from the group consisting of porcine gelatin, beef gelatin, and fish gelatin. In the same or other examples, the liquid is a natural food flavor composition.

In a second aspect of the present disclosure, an animal toy is provided which comprises a fabric enclosure that comprises a plush fabric outer layer and an inner fabric layer. The fabric enclosure encloses a fill. The fill is preferably compressible and is more preferably a compressible, polyester fill. A plurality of microcapsules comprising a natural food flavor composition encapsulated in a protein shell is incorporated in the inner fabric layer. In certain examples, the food flavor composition is liquid. In the same or other examples, the natural protein shell comprises a hydrocolloid, more preferably a gelatin, and still more preferably, one selected from the group consisting of porcine gelatin, beef gelatin, and fish gelatin. The microcapsule shells are preferably crosslinked.

In a third aspect of the present disclosure, a method of making an animal toy is provided. The method comprises providing a slurry comprising plurality of microcapsules, wherein the microcapsules comprise a natural flavor composition encapsulated in a protein shell. The shell is preferably cross-linked. The method further comprises immersing a mesh fabric in the slurry. In certain examples, the method further comprises agitating the immersed mesh fabric. In the same or other examples, the method further comprises removing the mesh fabric from the slurry and extracting retained water from the mesh fabric. In the same or other examples, the method further comprises forming a fabric enclosure comprising a plush outer layer and the mesh fabric as an inner layer and filling the fabric enclosure with a fill material. The fill is preferably compressible and is more preferably a compressible polyester fill.

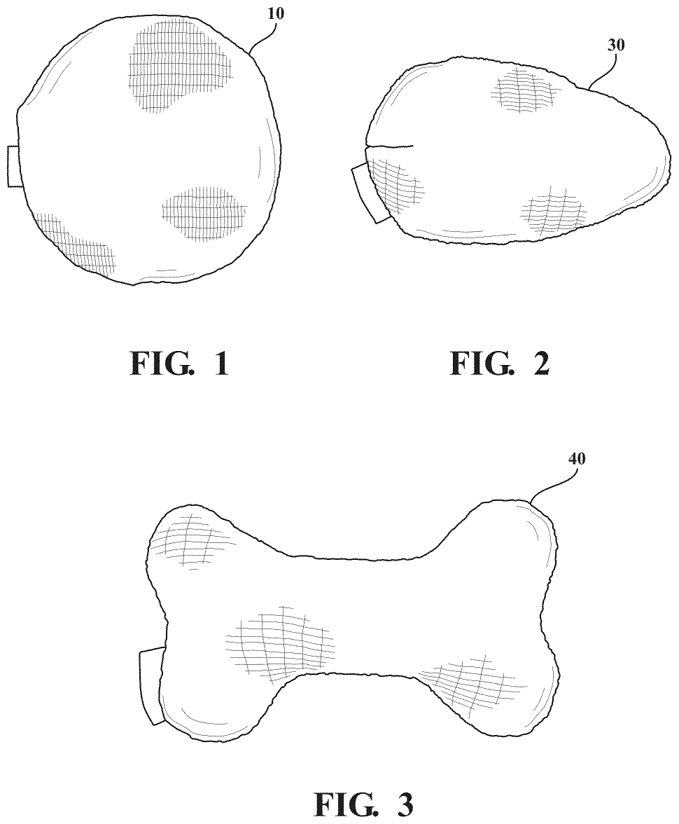

Referring to FIGS. 1-3, three stuffed, plush animal toys 10, 30, and 40 are depicted. Toy 10 is a disk, toy 30 is an egg, and toy 40 is a bone. As used herein the term “plush” refers to toys with an outer fabric surface having a pile that is at least 0.3 cm high.

Each animal toy 10, 30, 40 comprises a fabric enclosure 12 (FIG. 5) formed from a fabric laminate 13. Fabric enclosure 12 encloses a compressible fill 16 material and also includes a liquid, natural food flavor composition. Exemplary natural flavor compositions suitable for the animal toys described herein include food flavors such as beef, chicken, peanut butter, cheddar cheese, roasted turkey, sweet potato pie, and bacon natural flavor compositions. However, other natural flavors and flavor systems may be used. In certain examples, the food flavor composition comprises, and preferably consists of, “natural flavors,” as defined in the April 2020 Revision of 21 C.F.R. § 101.22(a)(3). The natural flavors could potentially be incorporated in the outer plush fabric layer or the compressible fill as a dye. However, in preferred examples herein, they are provided as encapsulated liquids in microcapsules incorporated in an inner fabric layer that forms part of the fabric enclosure 12. It has been found that microencapsulating the natural food flavors and distributing the microcapsules on an inner fabric surface of the fabric enclosure allows the compositions to be selectively emitted from toy 10, 30, 40 in response to rupturing of the microcapsules by a pet while minimizing losses of the compositions that would occur if diffusion from the toy were continually ongoing.

In more preferred examples, the microcapsules are incorporated in a mesh layer that comprises part of the fabric enclosure 12. The fabric enclosure 12 is formed by cutting and sewing fabric laminate 13 into the shape of the toy 10, 30, 40. In preferred examples herein, the natural flavors taste like the flavor name (e.g., chicken, beef, bacon, turkey, cheddar cheese, sweet potato pie, peanut butter, etc.) but also have a scent consistent with and reminiscent of their flavor and are capable of diffusing from the toy 10, 30, 40 and maintaining the pet's interest when their protective microcapsules are ruptured, such as by an animal during play.

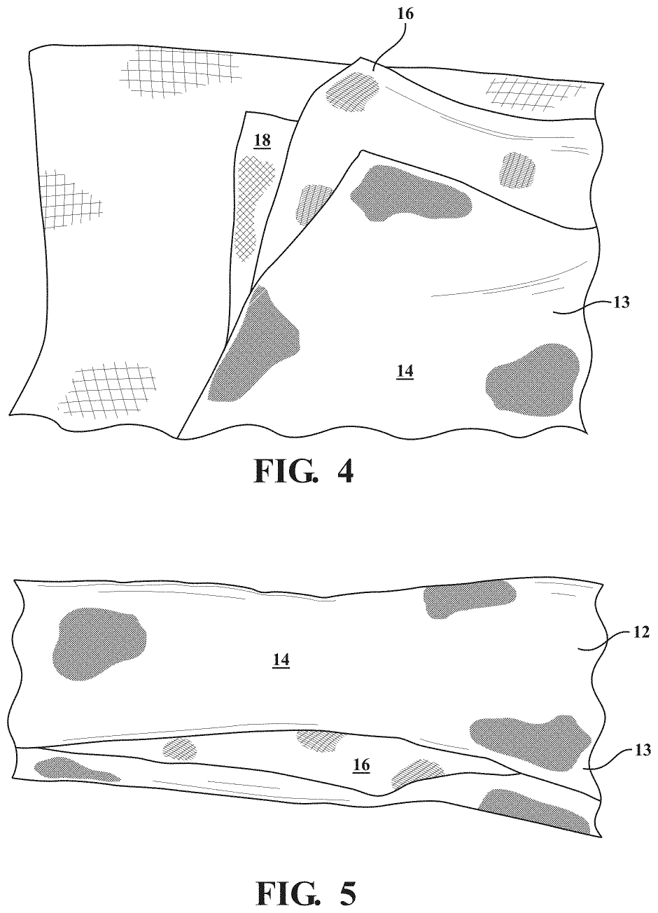

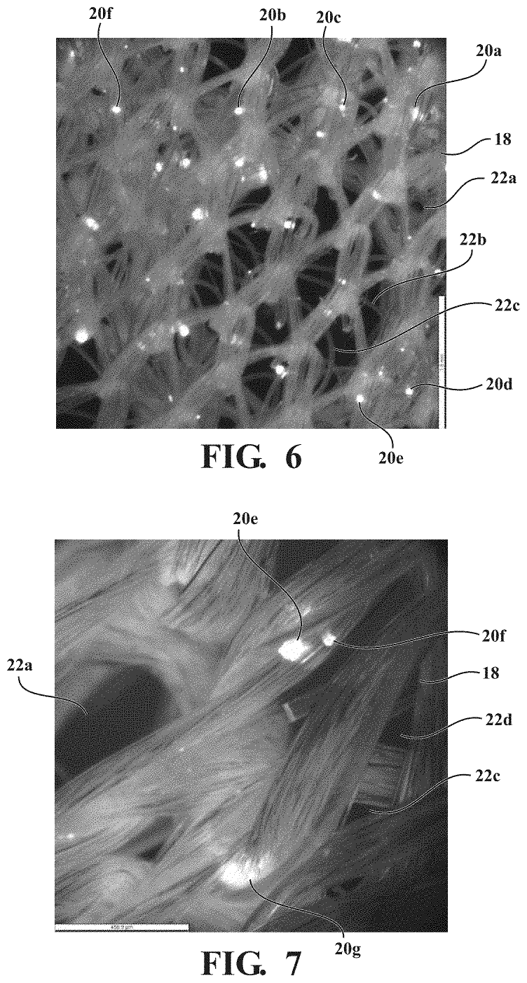

Referring to FIG. 4, toy 10, 30, 40 comprises a fabric laminate 13. Fabric laminate 13 comprises an outer plush fabric layer 14 and an inner mesh fabric layer 18. Two magnified views of mesh fabric layer 18 are shown in FIGS. 6 and 7. The outer plush fabric layer 14 preferably comprises a plush corduroy material that is sufficiently porous to allow the flavor compounds released from ruptured microcapsules to diffuse through it and reach concentrations at the toy's 10, 30, 40 outer surface which are detectable by dogs.

The mesh fabric layer 18 preferably comprises an open mesh. In certain examples, an open air mesh is used. An “air mesh” is a mesh that allows air to pass through it. In certain examples, mesh fabric layer 18 more preferably comprises a polyester air mesh fabric.

Microcapsules 20a-20h may be retained by the mesh fabric layer 18 in a number of ways. However, in the embodiment of FIGS. 6 and 7, microcapsules 20a-20h (only some of which are identified with reference numerals in the figures) are trapped in the mesh fibers and/or electrostatically attracted to the fibers. Mesh fabric layer 18 is preferably an open cell mesh to facilitate the diffusion of the flavor compositions released from their respective microcapsules during play with a dog. The open cell mesh layer is itself multi-layer mesh fabric that preferably has two different outer mesh layers that sandwich a mono yarn layer sometimes called an “air layer.” In one example, the outer layers have different mesh opening sizes that define a large opening side and a small opening side of the mesh fabric layer 18. The large openings on the large opening side and the small openings on the small opening side may have a variety of geometries, including circular, elliptical, and polygonal. In one example, the large openings are generally elliptical in shape and have a major axis (i.e., a major dimension) length of from about 3.0 mm to about 4.0 mm, preferably from about 3.2 mm to about 3.8 mm, and more preferably from about 3.4 mm to about 3.6 mm. The minor axis (i.e., a minor dimension) length of the openings ranges from about 2.0 mm to about 3.0 mm, preferably from about 2.2 mm to about 2.8 mm, and more preferably from about 2.4 mm to about 2.6 mm. The small openings on the small opening side may be elliptical or have a polygonal shape, but in one example have a rhombic shape with a major axis (i.e., a major dimension) length ranging from about 0.8 mm to about 1.6 mm, preferably from about 0.9 mm to about 1.5 mm, and more preferably from about 1.0 mm to about 1.4 mm The small openings are positioned within the large openings and thus define a “net area” or limiting opening area that extends from one side of the fabric to another ranging from about 0.2 mm² to about 0.8 mm², preferably from about 0.3 mm² to about 0.7 mm², and more preferably from about 0.4 mm² to about 0.6 mm². The net area of the larger openings ranges from about 22 mm² to about 32 mm², preferably from about 24 mm² to about 30 mm², and more preferably from about 24 mm² to about 26 mm². The mesh openings may also be characterized based on the sum of the open areas of the smaller mesh openings on the small opening side aligned with larger openings on the large opening side of mesh fabric layer 18.

The center to center spacing of the larger openings is from about 3 mm to about 10 mm, preferably from about 4 mm to about 8 mm, and more preferably from about 6 mm to about 7 mm. The mesh density (i.e., the number of the smaller through openings on the small opening side of mesh fabric 18 per unit area of mesh fabric layer 18) is from about 20,000 to 30,000 holes per square meter, preferably from about 23,000 to about 27,000 holes per square meter, and still more preferably from about 25,000 to about 26,000 holes per square meter of the mesh fabric layer area.

In the example of FIGS. 6 and 7, the mesh openings have a major dimension (i.e., the largest dimension of the mesh on the small opening layer of the mesh fabric layer 18) that is about 2 to about 10 times as large as the major dimension of the microcapsules. However, in an alternative implementation, the mesh openings may be sized to trap the microcapsules.

In certain preferred examples, the fabric laminate 13 further comprises a bite-resistant backing layer 16 between the mesh fabric layer 18 and the outer plush fabric layer 14. In certain preferred examples, the bite-resistant backing layer 16 comprises a felt material. In the same or other examples, the bite-resistant backing layer 16 comprises polyethylene. Layers 14, 16, and 18 may be bonded or attached to one another using known techniques. In the Example of FIG. 5, layers 14, 16, and 18 are heat bonded together. Outer plush fabric layer 14 has a mass per unit area of from about 150 to about 300 g/m², preferably from about 180 to about 270 g/m² and still more preferably from about 210 to about 230 g/m². Bite-resistant backing layer 16 has a mass per unit area of from about 150 to about 250 g/m2, preferably from about 170 to about 230 g/m² and still more preferably from about 190 to about 210 g/m². Mesh fabric layer 18 has a mass per unit area of from about 120 to about 170 g/m², preferably from about 130 g/m² to about 160 g/m², and more preferably from about 140 g/m² to about 150 g/m².

The microcapsule shell and the encapsulated food flavor composition are preferably “natural” as defined in 21 C.F.R. § 101.22(a)(3). In certain preferred embodiments, the microcapsule shells comprise, and preferably consist essentially of, protein. The protein is preferably a hydrocolloid, more preferably, a gelatin, and still more preferably one selected from the group consisting of porcine gelatin, beef gelatin and fish gelatin. The shells are preferably cross-linked.

The flavor composition is preferably a liquid and is also preferably immiscible in water. The flavor composition also preferably comprises a solution that includes one or more food flavor compounds and a solvent. In one embodiment, a flavor composition according to the present disclosure may include a characterizing flavor. The term “characterizing flavor” refers to a flavor comprising one or more food flavor compounds which is perceived by an individual to be predominant upon consumption by the individual. In one embodiment, the characterizing flavor may be a meat flavor, for example, beef, chicken, bacon, or turkey. In another embodiment, the characterizing flavor may be a dairy flavor such as cheddar cheese, or a flavor such as peanut butter or sweet potato. Suitable characterizing flavors for each of the foregoing food flavor compositions include those available from Givaudan Flavors Corporation. The flavor compositions and characterizing flavors are preferably selected to give off an aroma reminiscent of the flavor upon rupture of the flavor microcapsules. Thus, the flavor compositions are preferably formulated to provide a characterizing flavor vapor pressure that facilitates emission of the aroma through the toy 10, 30, 40. In certain examples of meat characterizing flavors, aldehyde and alcohol compounds may be used. Examples of suitable meat characterizing flavors may be found, for example, in US Published Patent Application No. 2020/0288758, the entirety of which is hereby incorporated by reference.

The solvent component of the flavor composition is one or more natural, organic compounds. Suitable solvents include water-immiscible carboxylic acid triglyceride esters, such as medium chain triglyceride (“MCT”) compounds as well as vegetable oils such as sunflower oil, canola oil, and peanut oil. MCTs comprise a group of triglycerides having three medium chain length (about 6-12 carbon) fatty acid molecules esterified to a glycerol molecule. In one example, the solvent consists essentially of—or consists of—a mixture of decanoyl and octanoyl glycerides (which are species of MCTs in which glycerol molecules have been esterified with three medium chain fatty acid molecules, such as decanoic acid or octanoic acid molecules).

On a dry basis, the amount of the food flavor composition is preferably from about 85 percent to about 95 percent, more preferably from about 87 percent to about 93 percent, and still more preferably from about 89 to about 91 percent by weight of the microcapsules. The liquid component of the microcapsules comprises from about 80 to about 95 percent, preferably from about 82 to about 92 percent, and more preferably from about 85 to about 89 percent solvent by weight of the total liquid food flavor composition encapsulated by the microcapsules.

The amount of the microcapsule shell is preferably from about 15 percent to about 5 percent, preferably from about 13 percent to about 7 percent, and still more preferably from about 11 percent to about 9 percent by weight of the microcapsules. The toy 10, 30, 40 overall comprises the flavor microcapsules in an amount ranging from about one percent to about 6 percent, preferably from about 2 percent to about 5 percent, and still more preferably from about 3 percent to about 4 percent by weight of the toy.

The microcapsules are preferably formed by a complex coacervation process. Complex coacervation is a phenomenon in which cationic and anionic water-soluble polymers interact in water to form a liquid, polymer-rich phase called a complex coacervate. This coacervate is used to form a microcapsule shell (see FIG. 3). Gelatin is frequently the cationic polymer used. A variety of natural and synthetic anionic water-soluble polymers interact with gelatin to form a complex coacervate. Gum acacia is one such anionic, water-soluble polymer. When the complex coacervate forms, it is in equilibrium with a dilute solution called the supernatant. The supernatant acts as the continuous phase in which the complex coacervate is dispersed. If a water-insoluble core material such as a flavor or fat is dispersed in the system, each droplet or particle of dispersed core material is spontaneously coated with a thin film of coacervate provided that the coacervate adsorbs on the surface of the dispersed oil droplets. When this liquid film is gelled, capsules are formed. The ‘wet’ complex coacervate gel is a very rubbery shell that deforms extensively without rupturing. In order to increase the strength of the water-swollen shell and create a gel structure that is not thermally reversible, complex coacervate capsules shells are typically cross-linked.

In accordance with a preferred method of making the microcapsules, gelatin (e.g., porcine, beef, or fish gelatin) is added to water along with carboxymethyl cellulose (CMC) and gum acacia. The flavor composition is also added. In aqueous solution, gelatin is a cationic (positively charged) biopolymer. Both CMC and gum acacia are anionic (negatively charged) biopolymers. Other suitable anionic biopolymers include pectin, sodium alginate, carrageenan, gellan gum, and sodium caseinate. The concentrations of the flavor composition, gelatin, CMC and gum acacia in the aqueous solution, and the temperature, and/or the pH of the solution are adjusted using known techniques to promote the formation of a coacervate layer comprising the gelatin, CMC, and gum acacia.

Once the reaction between the cationic and anionic biopolymers has completed to form the microcapsules, a cross-linker is added in an effective amount to cross-link the coacervate layer and form a cross-linked shell, thereby creating an aqueous microcapsule slurry. Suitable cross-linkers include food grade crosslinkers such as transglutaminase and glutaraldehyde. Following cross-linking, a preservative is added to protect the slurry from microbiological contamination. In one example, sodium benzoate is added as a preservative after adjusting the slurry pH to allow the sodium benzoate to carry out its preservative function. At this point, in certain examples, the microcapsules are present in an amount ranging from about 10 percent to about 30 percent, preferably from about 15 percent to about 25 percent, and more preferably from about 18 to about 22 percent by weight of the slurry. In the same or other examples, the slurry contains water in an amount ranging from about 90 percent to about 70 percent, preferably from about 85 percent to about 75 percent by weight, and more preferably from about 82 percent to about 78 percent by weight of the slurry. The resulting microcapsules are generally football or lemon shaped with tails on each end and have a distribution of sizes in which all of the microcapsules have a major dimension (i.e., the longest dimension along any axis) of less than 400 microns, preferably less than 350 microns, and more preferably less than 300 microns. The distribution is generally Gaussian with a mean major dimension that is from 50 microns to 200 microns, preferably from about 70 microns to about 180 microns, and more preferably from about 100 microns to about 150 microns. As a result, some microcapsules will have a major dimension of less than about 100 microns, and some will have a major dimension above 200 microns, but most of the microcapsules will have a major dimension between 100 and 200 microns.

The microcapsules are preferably incorporated into toy 10, 30, 40 by immersing a mesh fabric used to form mesh fabric layer 18 into an aqueous slurry that contains the microcapsules and agitating the immersed mesh. In preferred examples, the amount of water in the slurry is reduced prior to transporting it for addition to the mesh. The increased solids slurry comprises from about 25 percent to about 45 percent, preferably from about 28 percent to about 42 percent, and more preferably from about 30 percent to about 35 percent microcapsules by weight of the slurry. At the same time, the increased solids slurry comprises from about 75 percent to about 55 percent, preferably from about 72 percent to about 58 percent, and more preferably from about 70 percent to about 65 percent water by weight of the slurry.

In preferred examples, the animal toy 10, 30, 40 (i.e., including the fabric encapsulating layer, the compressible filling, and the microcapsules and contents thereof) is non-toxic. As used herein, the term “non-toxic”, as it pertains to an animal toy or component thereof, means that no compound on the list of “Chemicals of High Concern for Children (CHCC)” in the State of Washington (as defined by the Revised Code of Washington, Chapter 70.240.040 and the Washington Administrative Code chapter 173-334) is present in an amount greater than the detection limit of 30 ppm by weight of the animal toy or component thereof, respectively. In preferred examples, the encapsulated food flavor composition and/or the entire microcapsule (including the encapsulated composition) consists exclusively of ingredients registered with FEMA GRAS (Flavor & Extract Manufacturers Association and Generally Regarded as Safe). In the same or other examples, the animal toy complies with Intertek Pet Toy Test Protocol ITS-08001-US, Version 11 and/or Intertek Toy Test Protocol ITS-16001-US, Version 23.0. In the same or other preferred examples, the animal toy complies with the Consumer Product Safety Improvement Act (CPSIA) and/or California Proposition 65. In the same or other preferred examples, each of the ingredients in the food flavor composition and/or the microcapsule shell are selected to be compliant with the 2021 Official Publication (OP) of the Association of American Feed Control Officials (AAFCO).

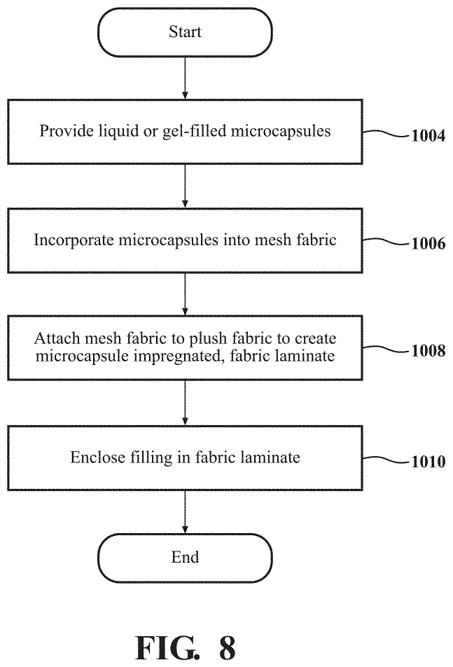

A method of making a plush toy 10, 30, 40 will now be described with reference to FIG. 8. In accordance with the method, microcapsules containing a natural food flavor scent of the type described previously are provided in step 1004. The microcapsules preferably comprise a protein shell that is more preferably cross-linked and are also preferably supplied as an aqueous slurry. The slurry preferably comprises from about 25 percent to about 45 percent, preferably from about 28 percent to about 42 percent, and more preferably from about 30 percent to about 35 percent microcapsules by weight of the slurry. At the same time, the slurry comprises from about 75 percent to about 55 percent, preferably from about 72 percent to about 58 percent, and more preferably from about 70 percent to about 65 percent water by weight of the slurry.

In step 1006 the microcapsules are incorporated into the mesh fabric layer 18. The incorporation step is preferably carried out to facilitate one or more desired modes of microcapsule retention by the mesh fabric layer 18, such as microcapsule trapping in the mesh openings, microcapsule trapping between fibers comprising the mesh, and electrostatic attraction between the microcapsules and the mesh fabric layer 18. In preferred examples herein, the microcapsules are retained to the mesh by entrapment by the fibers and/or by electrostatic attraction. Without wishing to be bound by any theory, it is believed that the selection of the microcapsule shell material and the mesh fabric layer 18 material, along with the method of incorporating the microcapsules in the mesh fabric layer 18, can cause the microcapsule shells and the mesh fabric layer 18 to develop opposite electrical charges that result in electrostatic attraction.

In step 1008 a microcapsule impregnated fabric laminate 13 is formed by attaching the mesh fabric layer 18 to the outer plush fabric layer 14. In a preferred example, the attachment is performed by heat bonding the two layers directly or indirectly. If bite-resistant backing layer 16 is provided, it is also attached to the mesh fabric layer 18 and the outer plush fabric layer 14, preferably by heat bonding.

The fabric laminate 13 is then cut into the shape of toy 10, 30, 40 and sewn to form fabric enclosure 12. An opening (such as opening 17 in FIG. 5) is formed to receive fill 16, and in step 1010 the fill 16 is inserted into the opening 17. Opening 17 is then sewn closed.

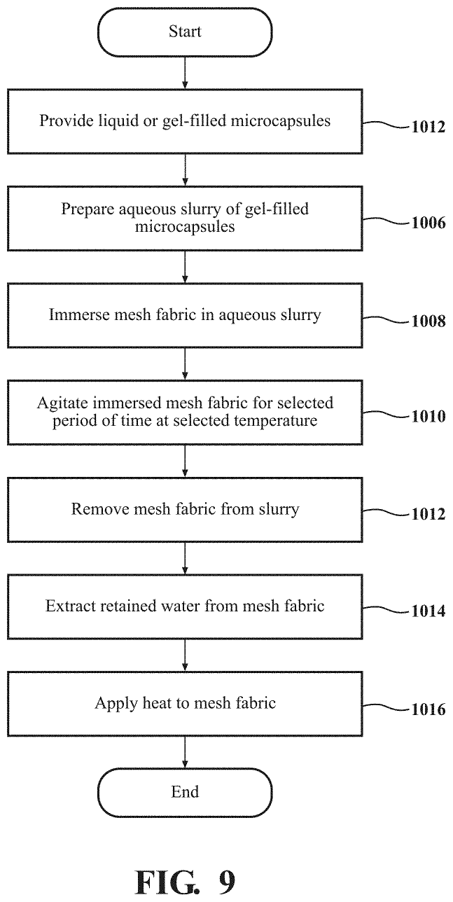

FIG. 9 illustrates an exemplary method of carrying out step 1006 of FIG. 8 to incorporate natural food flavor-containing microcapsules into mesh fabric layer 18. In step 1006 an aqueous slurry of liquid or gel-filled microcapsules is provided. The microcapsules preferably comprise a liquid, natural food flavor composition. The natural food flavor composition is preferably FEMA GRAS and/or AAFCO compliant, and is preferably provided as a solution comprising, consisting essentially of, or consisting of one or more FEMA GRAS and/or AAFCO compliant natural food flavor compounds and a FEMA GRAS and/or AAFCO compliant natural organic solvent of the type described previously. The aqueous slurry is preferably formed by adding to a volume of water the product of a complex coacervation process that itself yields an aqueous slurry of the microcapsules. The microcapsules preferably comprise a cross-linked protein shell and an encapsulated natural liquid food flavor composition. The natural liquid food flavor composition preferably comprises a characterizing flavor comprising one or more food flavor compounds and an organic solvent of the type described previously.

In step 1008 the mesh fabric forming mesh fabric layer 18 is immersed in the aqueous slurry of step 1006. The immersed mesh is then agitated at for a selected period of time at one or more selected temperatures in step 1010. Step 1010 may be carried out, for example, by a commercial washing machine. Agitation times of from about 5 minutes to about 30 minutes may be used. Agitation times of from about 7 minutes to about 15 minutes are preferred, and agitation times of from about 8 minutes to about 12 minutes are more preferred. Step 1010 is carried out at one or more agitation temperatures ranging from about 30° C. to about 60° C., preferably from about 35° C. to about 55° C., and more preferably from about 40° C. to about 50° C. Although not separately shown in FIG. 9, in certain examples, the mesh remains immersed in the slurry without agitation for a selected period of time ranging from about 0.5 hour to about 2 hours, preferably from about 0.7 hours to about 1.5 hours, and more preferably from about 0.8 hours to about 1.2 hours.

Retained water is extracted from the mesh fabric layer 18 in step 1014. In one example, the mesh fabric layer 18 is placed in a centrifuge that is operated at a rotational frequency and time selected to reduce the water content in the mesh fabric layer 18 to a level that can be removed by applying heat for a commercially reasonable period of time. In certain examples, centrifuge rotational frequencies of from about 15 rpm to about 35 rpm, preferably from about 20 rpm to about 30 rpm, and more preferably from about 23 rpm to about 27 rpm are used. In the same or other examples, the centrifuge is operated for from about 30 seconds to about 140 seconds, preferably from about 50 seconds to about 120 seconds, and more preferably from about 80 seconds to about 100 seconds. In step 1016 the mesh fabric layer 18 is heated, such as by drying it in a commercial dryer at a time and temperature selected to remove any remaining water content from the mesh fabric layer 18. Drying temperatures of from about 40° C. to about 80° C. are preferred. Drying temperatures ranging from about 50° C. to about 70° C. are more preferred, and drying temperatures ranging from about 55° C. to about 65° C. are still more preferred. The rotational frequency of the dryer in step 1016 is from about 800 rpm to about 1000 rpm, preferably from about 830 rpm to about 970 rpm, and more preferably from about 860 rpm to about 900 rpm.

Pet toys 10, 30, 40 made in accordance with the foregoing disclosure preferably withstand biting by a pet which is sufficient to rupture the natural, food flavor-containing microcapsules without compromising the integrity of the fabric laminate 13. In one example in which a bite-resistant backing layer 16 comprising a polyethylene felt is provided between a corduroy outer plush fabric layer 14 and polyester air mesh fabric layer 18, pet toy 10, 30, 40 achieves Newton Force to Puncture test scale scores of at least about 800N, preferably, at least about 1000N, more preferably, at least about 1500 N, and still more preferably at least about 2000N.

The foregoing descriptions of specific embodiments have been presented for purposes of illustration and description. They are not intended to be exhaustive or to limit the invention to the precise forms disclosed. Many modifications and variations are possible in light of the above teachings, with modifications and variations suited to the particular use contemplated.

What is claimed is:

1. An animal toy, comprising:
a fabric enclosure comprising an outer fabric layer and an inner mesh fabric layer;
a plurality of microcapsules comprising an encapsulated flavor composition, wherein the plurality of microcapsules is incorporated in the inner mesh fabric layer.

2. The animal toy of claim 1, further comprising a compressible fill material enclosed within the fabric enclosure.

3. The animal toy of claim 1, wherein the microcapsules have a protein shell, and the flavor composition is a liquid.

4. The animal toy of claim 3, wherein the protein shell comprises a cross-linked hydrocolloid.

5. The animal toy of claim 3, wherein the protein is natural.

6. The animal toy of claim 1, wherein the flavor composition is a natural food flavor composition.

7. The animal toy of claim 5, wherein the flavor composition consists of one or more AAFCO compliant ingredients.

8. The animal toy of claim 5, wherein the flavor composition consists of one or more FEMA GRAS ingredients.

9. The animal toy of claim 1, wherein the flavor composition is water immiscible.

10. The animal toy of claim 1, wherein the microcapsules in the plurality of microcapsules have a distribution of major dimension lengths, and the distribution has a mean of from about 50 microns to about 200 microns.

11. The animal toy of claim 1, wherein the mesh openings have a net area from one side of the inner mesh fabric layer mesh to an opposite side of the inner mesh fabric layer ranging from about 0.2 mm² to about 0.8 mm².

12. The animal toy of claim 1, wherein the outer fabric layer is a plush fabric layer.

13. The animal toy of claim 1, wherein the mesh in the mesh fabric layer is an open mesh.

14. The animal toy of claim 1, wherein the inner mesh fabric layer comprises fiber strands, and the microcapsules in the plurality of microcapsules are entrapped in the fiber strands.

15. The animal toy of claim 1, wherein the animal toy is non-toxic.

16. An animal toy, comprising:
a fabric enclosure comprising a plush fabric outer layer and an inner fabric layer, the fabric enclosure enclosing a fill;
a plurality of microcapsules comprising an encapsulated natural food flavor composition and a natural protein shell, wherein the plurality of microcapsules is incorporated in the inner fabric layer.

17. The animal toy of claim 16, wherein the food flavor composition is liquid.

18. The animal toy of claim 16, wherein the natural protein shell comprises a cross-linked hydrocolloid.

19. The animal toy of claim 16, wherein the food flavor composition consists of one or more FEMA GRAS ingredients.

20. The animal toy of claim 16, wherein the food flavor composition is water-immiscible.

21. The animal of claim 16, wherein the microcapsules in the plurality of microcapsules have a major dimension with a length of no less than 100 microns.

22. The animal toy of claim 16, wherein inner fabric layer comprises a mesh having openings, and the openings have a net open area from an inner side of the mesh to an outer side of the mesh ranging from about 0.2 mm² to about 0.8 mm².

23. A method of making an animal toy, comprising:
providing a slurry comprising a plurality of microcapsules that comprise an encapsulated natural flavor composition and a natural protein shell; and
immersing a mesh fabric in the slurry.

24. The method of claim 23, further comprising agitating the immersed mesh fabric.

25. The method of claim 23, further comprising:
removing the mesh fabric from the slurry; and
extracting retained water from the mesh fabric.

26. The method of claim 23, further comprising:
applying heat to dry the mesh fabric.

27. The method of claim 26, further comprising forming a fabric enclosure comprising a plush fabric outer layer and the mesh fabric as an inner layer, and filling the fabric enclosure with a compressible fill material.

28. The method of claim 23, wherein the natural protein shell comprises a cross-linked hydrocolloid.
